(19) United States
(12) Patent Application Publication
(10) Pub. No.: US 2009/0146337 A1
(43) Pub. Date: Jun. 11, 2009

(54) METHOD FOR PRODUCING EXTRUDED RESIN SHEET

(75) Inventors: Tomohiro MAEKAWA, Niihama-shi (JP); Kazuhiko Hatakeyama, Sanjo-shi (JP)

Correspondence Address: BIRCH STEWART KOLASCH & BIRCH, PO BOX 747, FALLS CHURCH, VA, 22040-0747, US

(73) Assignees: SUMITOMO CHEMICAL COMPANY, LIMITED, Tokyo (JP); ESCARBO SHEET CO., LTD, Mitsuke-shi (JP)

(21) Appl. No.: 12/328,480

(22) Filed: Dec. 4, 2008

(30) Foreign Application Priority Data
Dec. 7, 2007 (JP) 2007-317328

(51) Int. Cl. B28B 5/02

(52) U.S. Cl. 264/175

(57) ABSTRACT

Disclosed is a method for producing an extruded resin sheet comprising: heat-melting a thermoplastic resin and then extruding it into a sheet-form through a die; pressure-forming the extruded molten thermoplastic resin with a first roll and a second roll; and further pressure-forming the formed resin with the second roll and a third roll while wrapping the formed resin around the second roll, wherein the first roll is a roll having an outer circumferential surface of metal, the second roll is a highly rigid metal roll, and the third roll is an elastic roll having a metal thin film at its outer circumferential surface. The present invention provides a method for producing an extruded resin sheet with excellent appearance.

### BACKGROUND OF THE INVENTION

1. Field of the Invention

The present invention relates to a method for producing an extruded resin sheet, and particularly to a method for producing an extruded resin sheet with excellent appearance.

2. Description of the Related Art

Extruded resin sheets made of thermoplastic resin have been used in an extremely wide variety of applications, such as lighting fixtures, signboards, building materials, household electric appliances, optical applications including cellular phones, liquid crystal televisions and monitors. Generally, in the production of an extruded resin sheet made of thermoplastic resin, a molten thermoplastic resin is shaped into a sheet-like form while pressurizing and cooling it by nipping it between two rolls. In this process, if the cooling rate is too high, a strain will remain in a resin sheet produced. Therefore, a device that includes providing one or more rolls after the second roll and performing operations pressurizing and cooling stepwisely has been made for allowing strain to remain in an extruded resin sheet as less as possible.

For example, Japanese Patent Kokai Publication No. Hei 11(1999)-235747 discloses a roll configuration for pressure-forming a thermoplastic resin having three rolls in contact with each other. In this roll configuration, the first roll is an elastic roll having a metal thin film at its outer circumferential surface, and the second and the third rolls are highly rigid metal rolls. When this roll configuration is used, a molten thermoplastic resin is pressure-formed with the first and second rolls first, and then is further pressure-formed between the second and the third rolls while being wrapped around the second roll, and subsequently the thermoplastic resin is wrapped around the third roll.

It has been reported that in the above method for producing an extruded resin sheet, no strain remains in an extruded resin sheet because the first roll elastically deforms during a process of pressure-forming. However, when a thermoplastic resin in a molten state comes into contact with a roll, the resin is cooled and, at the same time, a surface is formed. Therefore, if the contact of a resin sheet with a roll becomes uneven, irregularities called “touching errors” will remain in the surface of the extruded resin sheet and, as a result, the appearance tends to become poor. This tendency is remarkable when an extruded resin sheet having a small thickness is formed.

That is, the thinner an extruded resin sheet, the more likely the sheet is cooled. When an extruded resin sheet pressure-formed with the first and the second rolls is thin, the surface of the resin sheet is cooled to harden before arriving at the third roll while being wrapped around the second roll, and the surface of the resin sheet will fail to come into close contact with the third roll evenly. As a result, irregularities will remain in the surface of the extruded resin sheet, resulting in poor appearance. This problem is remarkable particularly when an extruded resin sheet as thin as 2 mm or less in thickness is formed.

Simply increasing the temperature of the second roll or the third roll for preventing an extruded resin sheet from cooling rapidly will lead to problems such as that a resin sheet needs time to cool and that an extruded resin sheet becomes difficult to be detached from a roll. As a result, the production efficiency may deteriorate.

### SUMMARY OF THE INVENTION

An objective of the present invention is to provide a method for producing an extruded resin sheet with excellent appearance.

The present inventors investigated earnestly in order to solve the aforesaid subject. As a result, they found solving means composed of the following configurations, so that they have accomplished the present invention.

(1) A method for producing an extruded resin sheet comprising:

heat-melting a thermoplastic resin and then extruding it into a sheet-form through a die;

pressure-forming the extruded molten thermoplastic resin with a first roll and a second roll; and

further pressure-forming the formed resin with the second roll and a third roll while wrapping the formed resin around the second roll, wherein the first roll is a roll having an outer circumferential surface of metal, the second roll is a highly rigid metal roll, and the third roll is an elastic roll having a metal thin film at its outer circumferential surface.

(2) The method for producing an extruded resin sheet according to foregoing item (1), wherein the molten thermoplastic resin nipped between the elastic roll and the metal roll is pressed areally and uniformly because the elastic roll elastically deforms concavely along the outer circumferential surface of the metal roll with the molten thermoplastic resin intervening therebetween, so that the metal roll and the elastic roll are placed in areal contact with the molten thermoplastic resin under pressure.

(3) The method for producing an extruded resin sheet according to the foregoing item (1), wherein the surface temperature (Tr) of the second and the third rolls is adjusted to within a range of (Th−20° C.)≦Tr≦(Th+20° C.) wherein Th is heat distortion temperature of the thermoplastic resin constituting the extruded resin film.

(4) The method for producing an extruded resin sheet according to the foregoing item (1), wherein a contact length of the second roll and the third roll is from 1 to 15 mm.

(5) The method for producing an extruded resin sheet according to the foregoing item (1), wherein a pressing linear pressure between the second roll and the third roll is from 1 to 70 kgf/cm.

(6) The method for producing an extruded resin sheet according to the foregoing item (1), wherein the third roll comprises an almost solidly-cylindrical core roll, a hollowly-cylindrical metal thin film disposed so that it covers the outer circumferential surface of the core roll, and a fluid enclosed between the core roll and the metal thin film.

(7) The method for producing an extruded resin sheet according to the foregoing item (1), wherein the first roll is an elastic roll having a metal thin film at its outer circumferential surface.

(8) The method for producing an extruded resin sheet according to the foregoing item (1), wherein the surface temperature (Tr) of the first to the third rolls is adjusted to within a range of (Th−20° C.)≦Tr≦(Th+20° C.) wherein Th is heat distortion temperature of the thermoplastic resin constituting the extruded resin film.

(9) The method for producing an extruded resin sheet according to the foregoing item (1), wherein the extruded resin sheet has a thickness of 2 mm or less.

### BRIEF DESCRIPTION OF THE DRAWINGS

FIG. 1 is a schematic illustration showing the method for producing an extruded resin sheet according to one embodiment of the present invention;

FIG. 2 is a schematic cross-sectional illustration showing the roll configuration according to one embodiment of the present invention; and

FIG. 3 is a schematic cross-sectional illustration showing the roll configuration according to another embodiment of the present invention.

### DETAILED DESCRIPTION OF THE INVENTION

The extruded resin sheet of the present invention is made of a thermoplastic resin. The thermoplastic resin may, without any particular limitations, be any resin which can be melt-processed, for example, general purpose plastics or engineering plastics such as polyvinyl chloride resin, acrylonitrile-butadiene-styrene resin, low density polyethylene resin, high density polyethylene resin, linear low density polyethylene resin, polystyrene resin, polypropylene resin, acrylonitrile-styrene resin, cellulose acetate resin, ethylene-vinyl acetate resin, acryl-acrylonitrile-styrene resin, acryl-chlorinated polyethylene resin, ethylene-vinyl alcohol resin, fluororesin, methyl methacrylate resin, methyl methacrylate-styrene resin, polyacetal resin, polyamide resin, polyethylene terephthalate resin, aromatic polycarbonate resin, polysulfone resin, polyether sulfone resin, methylpentene resin, polyarylate resin, polybutylene terephthalate, resin which contains an ethylenically unsaturated monomer unit with alicyclic structure, polyphenylene sulfide resin, polyphenylene oxide resin, polyetheretherketone resin; and rubbery polymers such as polyvinyl chloride-based elastomer, chlorinated polyethylene, ethylene-ethyl acrylate resin, thermoplastic polyurethane elastomer, thermoplastic polyester elastomer, ionomer resin, styrene-butadiene block polymer, ethylene-propylene rubber) polybutadiene resin, and acrylic rubber. These may be used singly or in the form of a blend of two or more species.

Among such resins, preferred is a resin selected from the group consisting of a methyl methacrylate-based resin containing 50% by weight or more of methyl methacrylate units, which resin is of good optical properties, a resin composition comprising 100 parts by weight of the foregoing methyl methacrylate-based resin and 100 parts by weight or less of a rubbery polymer added thereto, a styrene-based resin containing 50% by weight or more of styrene units, a resin composition comprising 100 parts by weight of the foregoing styrene-based resin and 100 parts by weight or less of a rubbery polymer added thereto, an aromatic polycarbonate resin and a resin which contains an ethylenically unsaturated monomer unit with alicyclic structure.

The methyl methacrylate-based resin containing 50% by weight or more of methyl methacrylate units is a polymer which contains methyl methacrylate units as monomeric units. The content of the methyl methacrylate units is 50% by weight or more, more preferably is 70% by weight or more, and may be 100% by weight. A polymer having a methyl methacrylate unit content of 100% by weight is a methyl methacrylate homopolymer, which is obtained by polymerizing methyl methacrylate only.

Such a methyl methacrylate polymer may be a copolymer of methyl methacrylate and a monomer which can be copolymerized therewith. Examples of the monomer which can be copolymerized with methyl methacrylate include methacrylic esters other than methyl methacrylate. Examples of such methacrylic esters include ethyl methacrylate, butyl methacrylate, cyclohexyl methacrylate, phenyl methacrylate, benzyl methacrylate, 2-ethylhexyl methacrylate and 2-hydroxyethyl methacrylate. Further examples include acrylic esters such as methyl acrylate, ethyl acrylate, butyl acrylate, cyclohexyl acrylate, phenyl acrylate, benzyl acrylate, 2-ethylhexyl acrylate and 2-hydroxyethyl acrylate; unsaturated acids such as methacrylic add and acrylic add; halogenated styrenes such as chlorostyrene and bromostyrene; substituted styrenes, for example, alkyl styrenes such as vinyltoluene and α-methylstyrene; acrylonitrile, methacrylonitrile, maleic anhydride, phenylmaleimide and cyclohexylmaleimide. Such monomers may be used either singly or in combination.

The rubbery polymer in the present invention includes acrylic multilayer-structured polymers and graft copolymers obtained by graft polymerizing 95 to 20 parts by weight of an ethylenically unsaturated monomer, especially an acrylic unsaturated monomer, to 5 to 80 parts by weight of a rubbery polymer.

The acrylic multilayer-structured polymers include products having 20 to 60 parts by weight of a rubber elastic layer or elastomer layer enclosed and a hard layer as the outermost layer, and also may be products further having a hard layer as the innermost layer.

The rubber elastic layer or elastomer layer is a layer of an acrylic polymer having a glass transition point (Tg) of lower than 25° C. and is made of a polymer produced by crosslinking one or more monoethylenically unsaturated monomers, such as lower alkyl acrylate, lower alkyl methacrylate, lower alkoxy acrylate, cyanoethyl acrylate, acrylamide, hydroxy lower alkyl acrylate, hydroxy lower methacrylate, acrylic acid and methacrylic acid, with allyl methacrylate or the aforesaid multifunctional monomer.

A hard layer is a layer of an acrylic polymer having a Tg of 25° C. or higher and is made of a polymer composed of only or mainly an alkyl methacrylate having an alkyl group of 1 to 4 carbon atoms and a copolymerizable monofunctional monomer such as another alkyl methacrylate, an alkyl acrylate, styrene, substituted styrene, acrylonitrile and methacrylonitrile, or may alternatively be of a crosslinked polymer resulting from polymerization with further addition of a multifunctional monomer.

For examples, polymers disclosed in Japanese Patent Kokoku Publication No. She 55(1980)-27576, Japanese Patent Kokai Publication Nos. Hei 6(1994)-80739 and Sho 49(1974)-23292 correspond to such rubbery polymers.

Regarding the graft copolymers obtained by graft polymerizing 95 to 20 parts by weight of an ethylenically unsaturated monomer to 5 to 80 parts by weight of a rubbery polymer, diene rubbers, such as polybutadiene rubber, acrylonitrile-butadiene copolymer rubber and styrene-butadiene copolymer rubber; acrylic rubbers, such as polybutyl acrylate, polypropyl acrylate and poly-2-ethylhexyl acrylate; and ethylene-propylene-disconjugated diene-based rubbers may be used as the rubbery polymer. Examples of the ethylenic monomers and their mixtures to be used for graft polymerizing to such rubbery polymers include styrene, acrylonitrile and alkyl (meth)acrylate. For example, products disclosed in Japanese Patent Kokai Publication No. Sho 55(1980)-147514 and Japanese Patent Kokoku Publication No. Sho 47(1972)-9740 can be used as such graft copolymers.

The dispersion amount of a rubbery polymer is from 0 to 100 parts by weight, and preferably is from 3 to 50 parts by weight to 100 parts by weight of a methyl methacrylate-based or styrene-based resin. A case where the amount is greater than 100 parts by weight is undesirable because the rigidity of an extruded resin sheet will deteriorate.

The styrene-based resin containing 50% by weight or more of styrene units is a polymer which comprises styrene-based monofunctional monomer units as a major component, for example at 50% by weight or more, and may be either a homopolymer of a styrene-based monofunctional monomer or a copolymer of a styrene-based monofunctional monomer and a monofunctional monomer copolymerizable therewith.

The styrene-based monofunctional monomer is a compound that has a styrene skeleton and has, in the molecular, one radically polymerizable double bond, for example, styrene and substituted styrenes such as halogenated styrenes including chlorostyrene and bromostyrene, and alkylstyrenes including vinyltoluene and (X-methylstyrene.

The monofunctional monomer copolymerizable with a styrene-based monofunctional monomer is a compound that has, in the molecule, one radically polymerizable double bond and is copolymerizable at this double bond to a styrene-based monofunctional monomer. Examples of this type of monomer include methacrylic esters such as methyl methacrylate, ethyl methacrylate, butyl methacrylate, cyclohexyl methacrylate, phenyl methacrylate, benzyl methacrylate, 2-ethylhexyl methacrylate and 2-hydroxyethyl methacrylate; acrylic ester, such as methyl acrylate, ethyl acrylate, butyl acrylate, cyclohexyl acrylate, phenyl acrylate, benzyl acrylate, 2-ethylhexyl acrylate and 2-hydroxyethyl acrylate; and acrylonitrile. Methacrylic esters such as methyl methacrylate are used preferably. These are used singly or in combination.

The aromatic polycarbonate resin generally includes those obtained by polymerizing a carbonate prepolymer by a solid phase transesterification method or those obtained by polymerizing a cyclic carbonate compound by a ring-opening polymerization method as well as those obtained by causing a dihydric phenol and a carbonate precursor to react together by an interfacial polycondensation method or a melt transesterification method.

Representative examples of the dihydric phenol used here include hydroquinone, resorcinol, 4,4′-dihydroxydiphenyl, bis(4-hydroxyphenyl)methane, bis{(4-hydroxy-3,5-dimethyl)phenyl}methane, 1,1-bis(4-hydroxyphenyl)ethane, 1,1-bis(4-hydroxyphenyl)-1-phenylethane, 2,2-bis(4-hydroxyphenyl)propane (a common name is bisphenol A), 2,2-bis{(4-hydroxy-3-methyl)phenyl}propane, 2,2-bis{(4-hydroxy-3,5-dimethyl)phenyl}propane, 2,2-bis{(4-hydroxy-3,5-dibromo)phenyl}propane, 2,2-bis{(3-isopropyl-4-hydroxy)phenyl}propane, 2,2-bis{(4-hydroxy-3-phenyl)phenyl}propane, 2,2-bis(4-hydroxyphenyl)butane, 2,2-bis(4-hydroxyphenyl)-3-methylbutane, 2,2-bis(4-hydroxyphenyl)-3,3-dimethylbutane, 2,4-bis(4-hydroxyphenyl)-2-methylbutane, 2,2-bis(4-hydroxyphenyl)pentane, 2,2-bis(4-hydroxyphenyl)-4-methylpentane, 1,1-bis(4-hydroxyphenyl)cyclohexane, 1,1-bis(4-hydroxyphenyl)-4-isopropylcyclohexane, 1,1-bis(4-hydroxyphenyl)-3,3,5-trimethylcyclohexane, 9,9-bis(4-hydroxyphenyl)fluorene, 9,9-bis{(4-hydroxy-3-methyl)phenyl}fluorene, α,α′-bis(4-hydroxyphenyl)-o-diisopropylbenzene, α,α′-bis(4-hydroxyphenyl)-m-diisopropylbenzene, α,α′-bis(4-hydroxyphenyl)-p-diisopropylbenzene, 1,3-bis(4-hydroxyphenyl)-5,7-dimethyladamantane, 4,4′-dihydroxydiphenylsulfone, 4,4′-dihydroxydiphenylsulfoxide, 4,4′-dihydroxydiphenylsulfide, 4,4′-dihydroxydiphenyl ketone, 4,4′-dihydroxydiphenyl ether, and 4,4′-dihydroxydiphenyl ester. These may be used either singly or in the form of a mixture of two or more of them.

Particularly preferred is a homopolymer or copolymer obtained from at least one bisphenol selected from the group consisting of bisphenol A, 2,2-bis{(4-hydroxy-3-methyl)phenyl}propane, 2,2-bis(4-hydroxyphenyl)butane, 2,2-bis(4-hydroxyphenyl)-3-methylbutane, 2,2-bis(4-hydroxyphenyl)-3,3-dimethylbutane, 2,2-bis(4-hydroxyphenyl)-4-methylpentane, 1,1-bis(4-hydroxyphenyl)-3,3,5-trimethylcyclohexane and α,α′-bis(4-hydroxyphenyl)-m-diisopropylbenzene. Especially, a homopolymer of bisphenol A and a copolymer of 1,1-bis(4-hydroxyphenyl)-3,3,5-trimethylcyclohexane with at least one dihydric phenol selected from the group consisting of bisphenol A, 2,2-bis{(4-hydroxy-3-methyl)phenyl}propane and α,α′-bis(4-hydroxyphenyl)-m-diisopropylbenzene are used preferably.

For example, a carbonyl halide, a carbonate ester or a haloformate is used as a carbonate precursor. Specific examples include phosgene, diphenyl carbonate, or a dihaloformate of a dihydric phenol.

Examples of the resin which contains an ethylenically unsaturated monomer unit with alicyclic structure include norbornene-based polymers and vinyl alicyclic hydrocarbon-based polymers. That type of resin is characterized by containing an alicyclic structure in the repeating units of the polymer. The resin may have an alicyclic structure in the main chain and/or in a side chain. From the viewpoint of light transmissibility, resins having an alicyclic structure in the main chain are preferred.

Specific examples of such polymer resins containing an alicyclic structure include norbornene-based polymers, monocyclic olefin-based polymers, cyclic conjugated diene-based polymers, vinyl alicyclic hydrocarbon-based polymers, and their hydrogenated derivatives. Among these, hydrogenated norbornene-based polymers and vinyl alicyclic hydrocarbon-based polymers or their hydrogenated derivatives are preferred from the viewpoint of light transmissibility. Hydrogenated norbornene-based polymers are more preferable.

Depending on intended purpose, a light diffusing agent, a matting agent, a UV absorber, a surfactant, an impact resisting agent, a polymer type antistatic agent, an antioxidant, a flame retarder, a lubricant, a dye, a pigment, etc. may be added to the thermoplastic resin to be used in the present invention without any problems.

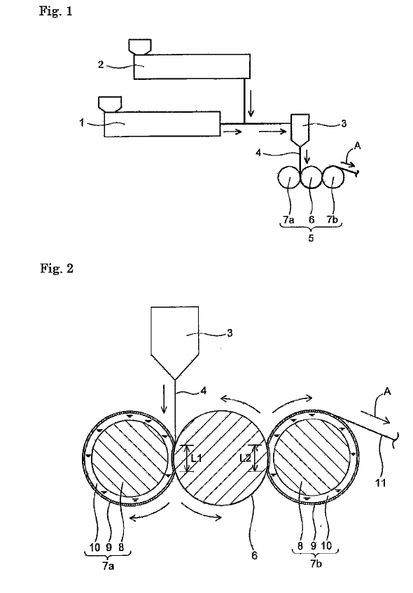

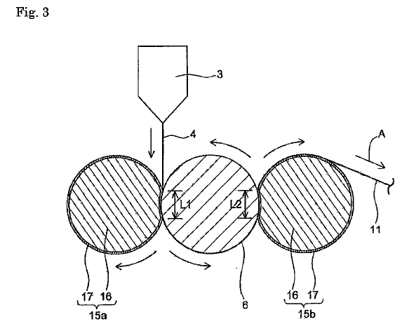

The extruded resin sheet of the present invention made of the aforementioned thermoplastic resin can be produced as follows. Hereafter, one embodiment of the method for producing an extruded resin sheet according to the present invention is described in detail with reference to drawings. FIG. 1 is a schematic illustration showing the method for producing an extruded resin sheet according to this embodiment. FIG. 2 is a schematic cross-sectional illustration showing the roll configuration according to this embodiment.

The extruded resin sheet of this embodiment can be produced by an ordinary extrusion forming method. That is, as shown in FIG. 1, a thermoplastic resin, which is to become a substrate, is extruded through a die 3 into a sheet form while it is heated and melt-kneaded in an extruder 1 and/or an extruder 2.

When making an extruded resin sheet which has a multilayer structure, it is possible to produce the film by a co-extrusion forming method. For example, the purpose can be attained by co-extruding a thermoplastic resin to become a substrate from the extruder 1 and another thermoplastic resin which is intended to laminate from the extruder 2. Co-extrusion can be performed by extruding and laminating the thermoplastic resins through the die 3 while heating and thereby melt-kneading the thermoplastic resins in the different extruders 1 and 2, respectively.

Examples of the extruders 1, 2 include single screw extruders and twin screw extruders. The number of the extruders is not necessarily limited to two and three or more extruders may be used. A T die is ordinarily used as the die 3. Besides single layer dies through which a thermoplastic resin is extruded in a single layer, multilayer dies through which two or more thermoplastic resins transferred under pressure independently from the extruders 1, 2 are laminated and co-extruded, such as feed block dies and muitimanifold dies, may be employed.

The molten thermoplastic resin 4 extruded through the die 3 as described above is passed through between three chill rolls 5 oppositely arranged almost horizontally, thereby being formed and cooled. The three chill rolls 5 comprise the first, the second and the third arranged in order along the direction in which the molten thermoplastic resin is hauled (the direction indicated with arrow A).

The first roll is not particularly restricted if it is of a type which has been used in applications of forming a thermoplastic resin into a sheet shape. For example, a roll made of an elastic rubber or a rigid metal may be used as the first roll. For example, use of a roll having an outer circumferential surface made of metal is preferred because this makes it easier to finish a resin sheet to have a smooth surface. Moreover, use of an elastic roll having a metal thin film at its outer circumferential surface is more preferred because this can reduce strain which remains in an extruded resin sheet.

A highly rigid metal roll is used as the second roll and an elastic roll having a metal thin film at its outer circumferential surface is used as the third roll. When these rolls are used in combination, it is possible to obtain extruded resin sheets with excellent appearance having a smooth surface at a high production efficiency.

In one preferable embodiment of the present invention, elastic rolls having metal thin film 9 on their outer circumferential surfaces, namely metal elastic rolls 7a and 7b, are used as the first and the third rolls and a highly rigid metal roll 6 is used as the second roll, as shown in FIG. 2. At least one of the first to the third rolls is connected to a rotary driving device, such as a motor, and the rolls are configured so that they can rotate at specified circumferential speeds.

The highly rigid metal roll 6 is a wrapper roll around which a thermoplastic resin after being nipped between the first and the second rolls is wrapped. Such a metal roll 6 is not particularly restricted, and ordinary metal rolls which have heretofore been used in extrusion forming may be employed. Specific examples include drilled rolls and spiral rolls. The surface state of the metal roll 6 may either be mirror-finished or have patterns, irregularities, etc.

The metal elastic rolls 7a and 7b each have a core roll 8, which is almost solidly-cylindrical and freely rotatable, and a hollowly-cylindrical metal thin film 9 which is arranged so that it can cover the circumferential surface of the core roll 8 and which will be in contact with the thermoplastic resin. A fluid 10 is enclosed in between the core roll 8 and the metal thin film 9, whereby the metal elastic rolls 7a and 7b can exhibit elasticity. The core roll 8 is not particularly restricted and may be made of stainless steel, for example.

The metal thin film 9 is made of stainless steel, for example. The thickness thereof preferably is about 2 to 5 mm. The metal thin film 9 preferably has flexurality, flexibility, and the like. The metal thin film preferably is of a seamless structure having no welded seam. The metal elastic rolls 7a and 7b each having such a metal thin film 9 have great ease of use because they excel in durability and they can be handled like ordinary mirror-finished rolls if the metal thin layer 9 is mirror finished and, if patterns or irregularities are provided to the metal thin film 9, they can serve as rolls capable of transferring the profile thereof.

The metal thin film 9 is fixed at both the ends of the core roll 8 and a fluid 10 is enclosed to between the core roll 8 and the metal thin film 9. Examples of the fluid 10 include water and oil. By controlling the temperature of the fluid 10, it is possible to make the metal elastic rolls 7a and 7b temperature-controllable. This makes it easy to adjust the surface temperature (Tr), described later, of the first to the third rolls and heat distortion temperature (Th) of the thermoplastic resin which constitutes an extruded resin sheet to have a specified relationship and, as a result, that can improve the productive capacity.

It is preferable that at least one of the metal elastic rolls 7a and 7b be configured to be temperature-controllable. For the temperature control, conventional controlling techniques such as PID control and ON-OFF control may be employed. Gas such as air can also be used instead of the fluid 10.

By using the first and the third rolls composed of the metal elastic rolls 7a and 7b and the second roll composed of the metal roll 6, it is possible to obtain an extruded resin sheet 11 of this embodiment which has no residual strain and has good appearance. That is, when a molten thermoplastic resin 4 extruded from the die 3 is nipped between the first roll composed of the metal elastic roll 7a and the second roll composed of the metal roll 6 and, the metal elastic roll 7a deforms elastically along the outer circumferential surface of the metal roll 6 with the molten thermoplastic resin 4 intervening therebetween, and the metal elastic roll 7a and the metal roll 6 come into contact with each other over a contact length L1 with separation by the molten thermoplastic resin 4. The metal elastic roll 7a and the metal roll 6 are thereby placed in areal contact with the molten thermoplastic resin 4 under pressure and the molten thermoplastic resin 4 nipped between these rolls is pressed areally and uniformly. As a result, it is possible to inhibit a strain from remaining in a resin sheet The contact length L1 used herein is the length in extrusion direction of the area where the metal roll 6 and the metal elastic roll 7a are in contact with the molten thermoplastic resin intervening therebetween

The contact length L1 may be any length such that it is possible to inhibit a strain from remaining in an extruded resin sheet 11 to be obtained. Therefore, the metal elastic roll 7a is required to have elasticity as high as that the metal elastic roll 7a elastically deforms to produce the appropriate contact length L1. The contact length L1 is 1 to 20 mm, preferably is 2 to 10 mm, and more preferably is 2 to 7 mm. The contact length L1 can be adjusted to a desired value by optionally adjusting the thickness of the metal thin film 9, the amount of the fluid 10 enclosed, etc.

The pressing linear pressure, which is the pressure between the metal elastic roll 7a and the metal roll 6 in contact with each other, is appropriately adjusted within a range where a proper contact length L1 is provided. Generally, the pressing linear pressure is from 0.1 kgf/cm to 50 kgf/cm, preferably is from 0.5 kgf/cm to 30 kgf/cm, and more preferably is from 1 kgf/cm to 25 kgf/cm. When the pressing linear pressure is too low, it becomes difficult to make pressure areally and uniformly, causing unevenness. When the pressure is too high, the resulted film tends to break, or the elastic roll tends to become short in life. The pressing linear pressure used herein is the pressure applied to a roll which is expressed as the value of pressure per 1 cm in roll width. In the case when a roll having a width of 100 cm is pressed at 300 kgf, the pressing linear pressure is 3 kgf/cm.

The thermoplastic resin after being nipped between the first and the second rolls is then further nipped between the second and the third rolls, thereby being shaped and cooled, while being wrapped around the second roll. In this embodiment, a metal elastic roll 7b is also used as the third roll. Therefore, even if the surface of the thermoplastic resin after being nipped between the first and the second rolls has been cooled to harden during a process that the thermoplastic resin is conveyed to the third roll while being wrapped around the second roll, the thermoplastic resin is pressed areally and uniformly by being nipped between the second roll composed of the metal roll 6 and the third roll composed of the metal elastic roll 7b, and the thermoplastic resin after being nipped between the second and the third rolls can thereby be come into close contact with the third roll evenly and, as a result, a smooth extruded resin sheet 11 in which strain, unevenness, and so on are inhibited to occur can be obtained.

The contact length L2 of the metal elastic roll 7b and the metal roll 6 may be any value such that the thermoplastic resin after being nipped between the second and the third rolls can be brought into close contact with the third roll evenly. The contact length L2 used herein is the length in extrusion direction of the area where the metal roll 6 and the metal elastic roll 7b are in contact with the molten thermoplastic resin intervening therebetween. Therefore, the metal elastic roll 7b is required to have elasticity as high as that the metal elastic roll 7b elastically deforms to produce the appropriate contact length L2. The contact length L2 is 1 to 15 mm, preferably is 2 to 7 mm, and more preferably is 2 to 5 mm.

The pressing linear pressure, which is the pressure between the metal elastic roll 7b and the metal roll 6 in contact with each other, is appropriately adjusted within a range where a proper contact length L2 is provided. Generally, the pressing linear pressure is from 1 kgf/cm to 70 kgf/cm, preferably is from 2 kgf/cm to 50 kgf/cm, and more preferably is from 3 kgf/cm to 30 kgf/cm. When the pressing linear pressure is too low, the extruded resin sheet tends to come into contact with the third roll unevenly. When the pressure is too high, the resulted film tends to break, or the elastic roll tends to become short in life

In shaping the molten thermoplastic resin 4 by nipping successively between the first and the second rolls and between the second and the third rolls, it is necessary to nip the molten thermoplastic resin 4 between these rolls before or during an operation of cooling the molten thermoplastic resin 4 to solidify. Specifically, it is preferable to adjust the surface temperature (Tr) of the second and the third rolls, and more preferably the first to the third rolls to the range of (Th−20° C.)≦Tr≦(Th+20° C.), preferably (T−15° C.)≦Tr≦(Th+10° C.), and more preferably (Th−10° C.)≦Tr≦(Th+5° C.), based on heat distortion temperature (Th) of the thermoplastic resin. While heat distortion temperature (Th) of the thermoplastic resin is not particularly limited, it is usually about 60 to 200° C. Heat distortion temperature (Th) of a thermoplastic resin is a temperature measured in accordance with ASTM D-648.

If the temperature of the second and the third rolls is controlled to fall within the above-mentioned range, an extruded resin sheet comes into close contact with the third roll evenly, so that the smoothness of the surface of the extruded resin sheet will increase. Moreover, if the temperature of the second and the third rolls is within the range, there is no fear that an extruded resin sheet cools slowly or that an extruded resin sheet becomes difficult to be detached from the rolls. If the temperature of the first and the second rolls is controlled to fall within the above-mentioned range, a molten thermoplastic resin is pressure-formed into a sheet shape in the course of solidification of the thermoplastic resin, so that the strain which remains in an extruded resin sheet is reduced.

In particular, when the thickness of the extruded resin sheet 11 is let be 2 mm or less, it is preferable to adopt the foregoing specified temperature ranges. Even if the surface of a thermoplastic resin after being nipped between the first and the second rolls has been cooled to harden in a process in which the thermoplastic resin is conveyed while being wrapped around the second roll, the thermoplastic resin having a hardened surface is pressed areally and uniformly while being softened moderately by being nipped between the second and the third rolls having a surface temperature (Tr) which has been set within the aforesaid specified range. Therefore, it is possible to ensure that the thermoplastic resin after nipping between the second and the third rolls comes into close contact with the third roll evenly.

On the other hand, if the surface temperature (Tr) is a temperature lower than (Th−20° C.), a resin tends to detach from the rolls and, as a result, touching errors tend to occur. Further, warpage tends to occur in the resin sheet in that condition. If the surface temperature (Tr) is a temperature higher than (Th+20° C.), a resin is difficult to be detached uniformly from the roll and, as a result, a transverse streak called a “touch mark” tends to be formed by the shock due to the detachment from the roll. Moreover, the production efficiency is lowered because, for example, it takes time for a resin sheet to cool.

The present invention is directed also to a multilayer resin sheet in which different materials are laminated. The surface temperature (Tr) in such a case is on the basis of a resin highest in heat distortion temperature (Th).

The thermoplastic resin which has been brought into even and, close contact with the third roll is wrapped around the third roll and then is hauled with a haul-off roll to obtain an extruded resin sheet 11. The thickness of an extruded resin sheet 11 preferably is 2 mm or less, more preferably is 0.04 to 1.2 mm, and even more preferably is 0.06 to 1.0 mm. If the thickness of an extruded resin sheet 11 is less than 0.04 mm, the resin in close contact with the surface of the third roll is resistant to detachment from the surface of the third roll and the resin easily wraps around the third roll. If the thickness of an extruded resin sheet 11 is greater than 2 mm, such thick resin is difficult to be handled in the form of a resin sheet. The thickness of an extruded resin sheet 11 can be adjusted by adjusting the thickness of a molten thermoplastic resin 4 to be extruded through a die 3, the clearance between chill rolls, and so on.

Next, another embodiment of the method for producing an extruded resin sheet according to the present invention is described. FIG. 3 is a schematic cross-sectional illustration showing the roll configuration according to this embodiment. In FIG. 3, the same constituents as those in FIGS. 1 and 2 are provided with the same symbols and explanation thereof is omitted.

As shown in FIG. 3, as to three chill rolls of this embodiment, the metal elastic rolls 15a and 15b are let be the first and the third rolls, respectively, and the highly rigid metal roll 6 is let be the second roll. The metal elastic rolls 15a and 15b are rolls in each of which the circumferential surface of a core roll 16, which is almost solidly-cylindrical and freely rotatable, is covered with a hollowly-cylindrical metal thin film 17.

The core roll 16 is made of an elastic material. The material which constitutes the core roll is not particularly restricted if it is an elastic material which has heretofore been used as a roll for forming films. Examples thereof include rubber rolls made of rubber such as silicone rubber. The metal elastic rolls 15a and 15b can thereby exhibit elasticity. The aforesaid contact lengths L1 and L2 and the pressing linear pressure can be adjusted to appropriate values also by adjusting the hardness of the rubber.

The metal thin film 17 is made of stainless steel, for example. The thickness thereof preferably is about 0.2 to 1 mm.

The metal elastic rolls 15a and 15b can be configured to be temperature-controllable by, for example, mounting back-up chill rolls to the metal elastic rolls 15a and 15b. Explanation about other specifications is omitted because they are the same as those in the embodiment previously described.

While several embodiments of the present invention have been described above, the present invention is not limited to the foregoing embodiments and various improvements or modifications may be made within the scope of the claims. For example, while the first and the third rolls are composed of elastic rolls of the same configuration in each of the foregoing embodiments, the present invention is not limited to the roll configuration according to each embodiment. For example, a roll configuration may be adopted that is according to an embodiment in which metal elastic rolls 7a and 7b according to one embodiment and metal elastic rolls 15a and 15b according to another embodiment. Specific examples include a roll configuration in which the metal elastic roll 7a according to one embodiment is let be the first roll and the metal elastic roll 15b according to another embodiment is let be the third roll.

In another possible embodiment, a plurality of rolls are disposed after the third roll, and the thermoplastic resin wrapped around the third roll is successively nipped between one roll and another roll next thereto to be wrapped.

According to the method of the present invention, an extruded resin sheet which has been pressure-formed with the first and the second rolls is nipped between the second roll composed of a highly rigid metal roll and the third roll composed of the aforesaid elastic roll. In this course, the elastic roll elastically deforms concavely along the outer circumferential surface of the metal roll with the molten thermoplastic resin intervening therebetween, so that the metal roll and the elastic roll are placed in areal contact with the molten thermoplastic resin under pressure. As a result, the extruded resin sheet is areally pressurized uniformly. Therefore, even if the surface of a resin sheet has been cooled to be somewhat hardened during a process that the resin sheet is conveyed to the third roll while being wrapped around the second roll, it is possible to bring the surface of the resin sheet into close contact with the third roll evenly, and it is possible to obtain an extruded resin sheet with excellent appearance having a smooth surface.

In the method of the present invention, if an elastic roll having a metal thin film at its outer circumferential surface is used also as the first roll, a resin sheet extruded through a die will be cooled while being areally, uniformly pressurized. As a result, a strain is inhibited from remaining in the resin sheet.

In particular, when the method of the present invention is applied in order to obtain an extruded resin sheet having a thickness of 2 mm or less, the method of the present invention, the usefulness of the present invention will increase more,

### EXAMPLES

The present invention will be described in more detail below with reference to Examples, but the invention is not limited to the Examples. The composition of the extrusion apparatus used in the following Examples and Comparative Examples is as follows:
Extruder 1: Screw diameter of 100 mm, single screw, with a vent (manufactured by Hitachi Zosen Corp.);
Extruder 2: Screw diameter of 35 mm, single screw, with a vent (manufactured by Hitachi Zosen Corp.);
Feed block: 2-Kind 2-layer distribution Manufactured by Hitachi Zosen Corp.);
Die 3: T die, lip width of 1500 mm, lip gap of 1 mm (manufactured by Hitachi Zosen Corp.);
Roll: Horizontal type, three chill rolls of 1600 mm in length, 300 mm φ in diameter.

Extruders 1, 2 and die 3 were arranged as shown in FIG. 1, and a feed block was arranged at a specified position. The three chill rolls, which were named the first, the second and the third rolls in order along the direction in which the molten thermoplastic resin was hauled (the direction indicated with arrow A), were configured as follows.

### <Roll Configuration 1>

The configuration shown in FIG. 2 was named Roll configuration 1. Specifically, the first to the third rolls were configured as follows.

### (The First Roll and the Third Roll)

The metal elastic rolls 7a and 7b, in which the metal thin film 9 was arranged so that it could cover the outer circumferential surface of the core roll 8 and the fluid 10 was filled to between the core roll 8 and the metal thin film 9, were used as the first and the third rolls. The core roll 8, the metal thin film 9, and the fluid 10 are as follows.
Core roll 8: Made of stainless steel;
Metal thin film 9: Mirror-finished metal sleeve made of stainless steel having a thickness of 2 mm (the first roll) or 3 mm (the third roll);
Fluid 10: Oil. The metal elastic rolls 7a and 7b were made temperature-controllable through temperature control of the oil. More specifically, the oil was made temperature-controllable through heating and cooling of the oil by ON-OFF control of a temperature controller, and the oil was circulated through between the core roll 8 and the metal thin film 9.

### (The Second Roll)

A mirror-finished stainless steel spiral roll was made a highly rigid metal roll 6, which was used as the second roll. The contact length L1, over which the metal elastic roll 7a and the metal roll 6 were in contact with each other, was adjusted to 4 mm and the pressing linear pressure was adjusted to 8 kgf/cm. The contact length L2, over which the metal elastic roll 7b and the metal roll 6 were in contact with each other, was adjusted to 3 mm and the pressing linear pressure was adjusted to 15 kgf/cm.

### <Roll Configuration 2>

Highly rigid metal rolls (mirror-finished stainless steel spiral rolls) were used as the first to the third rolls.

### <Roll Configuration 3>

Roll configuration 3 was configured in the same manner as roll configuration 1 shown above, except for using, instead of the metal elastic roll 7b, a highly-rigid metal roll 6 as the third roll. That is, a temperature-controllable metal elastic roll 7a was let be the first roll, and highly-rigid metal rolls 6 were let be the second and the third rolls.

The thermoplastic resins used in the following Examples and Comparative Examples are as follows.
Resin 1: Copolymer in which methyl methacrylate/methyl acrylate=94/6 (weight ratio). The heat distortion temperature (Th) was 100° C.
Resin 2: Polymer made up of aromatic polycarbonate (“CALIBRE 301-10” produced by Sumitomo Dow Limited). The heat distortion temperature (Th) was 140° C.
Resin 3: Copolymer in which methyl methacrylate/methyl acrylate=98/2 (weight ratio). The heat distortion temperature (Th) was 100° C.
Resin 4: Copolymer in which methyl methacrylate/styrene=60/40 (weight ratio, “PLANELOY KM-6A” produced by NIPPON A&L INC.). The heat distortion temperature (Th) was 100° C.
Resin 5: Polymer made up of styrene (“TOYO STYROL HRM-40” produced by Toyo Styrene Co., Ltd.). The heat distortion temperature (Th) was 100° C.
Resin 6: Acrylic resin-based composition in which 70% by weight of a copolymer in which methyl methacrylate/methyl acrylate=96/4 (weight ratio) was incorporated with 30% by weight of an acrylic multilayer elastic material obtained in the following Reference Example. The heat distortion temperature (Th) was 100° C.
Resin 7: Polymer which contains an ethylenically unsaturated monomer units with alicyclic structure (“ZEONOR 1020R” produced by ZEON Corp.). The heat distortion temperature (Th) was 100° C.

### Reference Example

### (Production of Rubbery Polymer)

In accordance with the method disclosed in the Example section of Japanese Patent Kokoku Publication No. She 55(1980)-27576, an acrylic multilayer elastic material of three-layer structure was produced. Specifically, 1700 g of ion exchanged water, 0.7 g of sodium carbonate and 0.3 g of sodium persulfate were charged into a glass reactor having a capacity of 5 L first, followed by stirring under nitrogen flow. Subsequently, 4.46 g of PELEX OT-P (produced by Kao Co., Ltd.), 150 g of ion exchanged water, 150 g of methyl methacrylate and 0.3 g of allyl methacrylate were charged and then heated to 75° C., followed by stirring for 150 minutes.

Then, a mixture of 689 g of butyl acrylate, 162 g of styrene and 17 of allyl methacrylate and a mixture of 0.85 g of sodium persulfate, 7.4 g of PELEX OT-P and 50 g of ion exchanged water were added through different inlet ports over 90 minutes, followed by polymerization for 90 minutes

After the completion of the polymerization, a mixture of 326 g of methyl acrylate and 14 g of ethyl acrylate, and 30 g of ion exchanged water containing 0.34 g of sodium persulfate dissolved therein were further added through different inlet ports over 30 minutes.

When the addition was finished, the mixture was further held for 60 minutes to complete the polymerization. A resulting latex was poured into a 0.5% aqueous aluminum chloride solution, so that a polymer was condensed. The polymer was washed with hot water 5 times and then dried to yield an acrylic multilayer elastic material.

### Examples 1, 2, 4 to 11 and Comparative Examples 1, 2, 5 to 12

### <Preparation of Extruded Resin Sheet>

The resin of the kind shown in Tables 1 and 2 was melt-kneaded in Extruder 1, and then was fed to the feed block and to the die 3, successively. Then, the molten thermoplastic resin 4 extruded through the die 3 was shaped and cooled by being caused to pass between the first to the third rolls. Thus, an extruded resin sheet having the thickness shown in Tables 1 and 2 was obtained.

In the sub-column “between the second and the third rolls” in the column “roll configuration” in Tables 1 and 2, the term “adhesion under pressure” means that a thermoplastic resin after being nipped between the first and the second rolls was further nipped between the second and the third rolls to be shaped and cooled while being wrapped around the second roll. The term “release” means that a thermoplastic resin after being nipped between the first and the second rolls was wrapped around the third roll to be shaped and cooled without being nipped between the second and the third rolls. “Surface temperature of the first roll”, “surface temperature of the second roll” and “surface temperature of the third roll” given in Tables 1 and 2 are values obtained by actually measuring the surface temperatures of the rolls.

### Examples 3, 12, 13, and Comparative Examples 3, 4, 13, 14

As resin layer A, the resin of the kind shown in Tables 1 and 2 was melt-kneaded in Extruder 1, and then fed to the feed block. On the other hand, as resin layer B, the resin of the kind shown in Tables 1 and 2 was melt-kneaded in Extruder 2, and then fed to the feed block. Co-extrusion forming was performed so that the resin layer A fed to the feed block from Extruder 1 would form a main layer and the resin layer B fed to the feed block from Extruder 2 would form a surface layer (one side/upper side).

Then, the molten thermoplastic resin extruded through the die 3 was shaped and cooled by being caused to pass between the first to the third rolls. Thus, an extruded resin sheet of bilayer structure having the thickness shown in Tables 1 and 2 was obtained. The “thickness” in the column of Extruder 1 and that of in the column of Extruder 2 in Tables 1 and 2 indicate the thickness of the resin layer A and that of the resin layer B, respectively. Moreover, “total thickness” in Tables 1 and 2 indicates the total thickness of an extruded resin sheet obtained.

### <Evaluation>

As to each of the extruded resin sheets obtained (Examples 1 to 13 and Comparative Examples 1 to 14), the state of close contact with the third roll and the appearance of an extruded resin sheet were evaluated. The method of the evaluations are shown below and the results of the evaluations are provided in Tables 1 and 2.

(State of Contact with the Third Roll)

The state of contact of a thermoplastic resin with the third roll was checked visually during extrusion forming. The used criteria for evaluation are as follows:
◯: The thermoplastic resin was in dose contact with the third roll evenly.
Δ: The thermoplastic resin was partially lifted off from the third roll.
×: The thermoplastic resin was almost not in contact with the third roll.

### (Appearance)

The condition of a resulting extruded resin sheet was checked visually. The used criteria for evaluation are as follows:
◯: The both surfaces are smooth and no problem is found.
Δ: The surfaces are almost smooth, but there are recesses or marks locally in the surfaces.
×: Streaks or recesses are recognized.

TABLE 1

| | | | | | | | | | | State | | | | |
|---|---|---|---|---|---|---|---|---|---|---|---|---|---|---|
| | Extruder 1 | | | Extruder 2 | | | | | | of | First | | | |
| | Resin | | | Resin | | | Total | Roll configuration | | contact | roll | Second roll | Third roll | |
| | Layer | | Thick- | layer | | Thick- | thick- | | Between | with | surface | surface | surface | |
| | A | Th | ness | B | Th | ness | ness | | second and | third | temp. | temp. | temp. | |
| | Kind | ° C. | mm | Kind | ° C. | mm | mm | Kind | third rolls | roll | ° C. | ° C. | ° C. | Appearance |
| Example. 1 | 1 | 100 | 0.3 | — | — | — | 0.3 | 1 | Compression | ◯ | 98 | 105 | 102 | ◯ |
| Comparative | 1 | 100 | 0.3 | — | — | — | 0.3 | 1 | Release | X | 98 | 105 | 102 | X |
| Example. 1 | | | | | | | | | | | | | | |
| Example. 2 | 6 | 100 | 0.4 | — | — | — | 0.4 | 1 | Compression | ◯ | 102 | 109 | 106 | ◯ |
| Comparative | 6 | 100 | 0.4 | — | — | — | 0.4 | 2 | Compression | X | 100 | 103 | 106 | X |
| Example. 2 | | | | | | | | | | | | | | |
| Example. 3 | 2 | 140 | 0.45 | 3 | 100 | 0.05 | 0.50 | 1 | Compression | ◯ | 130 | 130 | 152 | ◯ |
| Comparative | 2 | 140 | 0.45 | 3 | 100 | 0.05 | 0.50 | 2 | Compression | X | 130 | 120 | 145 | X |
| Example. 3 | | | | | | | | | | | | | | |
| Comparative | 2 | 140 | 0.45 | 3 | 100 | 0.05 | 0.50 | 3 | Compression | Δ | 130 | 120 | 148 | X |
| Example. 4 | | | | | | | | | | | | | | |
| Example. 4 | 4 | 100 | 1.2 | — | — | — | 1.2 | 1 | Compression | ◯ | 98 | 104 | 106 | ◯ |
| Comparative | 4 | 100 | 1.2 | — | — | — | 1.2 | 2 | Compression | Δ | 98 | 105 | 107 | Δ |
| Example. 5 | | | | | | | | | | | | | | |
| Example. 5 | 5 | 100 | 0.8 | — | — | — | 0.8 | 1 | Compression | ◯ | 97 | 103 | 104 | ◯ |
| Comparative | 5 | 100 | 0.8 | — | — | — | 0.8 | 2 | Compression | Δ | 97 | 103 | 105 | Δ |
| Example. 6 | | | | | | | | | | | | | | |
| Example. 6 | 3 | 100 | 0.4 | — | — | — | 0.4 | 1 | Compression | ◯ | 97 | 100 | 103 | ◯ |
| Comparative | 3 | 100 | 0.4 | — | — | — | 0.4 | 2 | Compression | Δ | 97 | 100 | 102 | Δ |
| Example. 7 | | | | | | | | | | | | | | |
| Example. 7 | 3 | 100 | 0.08 | — | — | — | 0.08 | 1 | Compression | ◯ | 96 | 102 | 95 | ◯ |
| Comparative | 3 | 100 | 0.08 | — | — | — | 0.08 | 3 | Compression | X | 96 | 102 | 97 | X |
| Example. 8 | | | | | | | | | | | | | | |
| Example. 8 | 6 | 100 | 0.13 | — | — | — | 0.13 | 1 | Compression | ◯ | 95 | 102 | 95 | ◯ |
| Comparative | 6 | 100 | 0.13 | — | — | — | 0.13 | 2 | Compression | X | 96 | 102 | 96 | X |
| Example. 9 | | | | | | | | | | | | | | |
| Example. 9 | 7 | 100 | 0.13 | — | — | — | 0.13 | 1 | Compression | ◯ | 93 | 100 | 99 | ◯ |
| Comparative | 7 | 100 | 0.13 | — | — | — | 0.13 | 3 | Compression | X | 94 | 100 | 98 | X |
| Example. 10 | | | | | | | | | | | | | | |

As shown in Table 1, in Examples 1 to 9, the thermoplastic resin after being nipped between the second and the third rolls was successfully brought into close contact with the third roll evenly and, as a result, a smooth extruded resin sheet in which strain, unevenness, and so on were inhibited to occur was obtained.

On the other hand, in Comparative Example 1, the roll configuration was the same as that of Examples 1 to 9, but a thermoplastic resin after being nipped between the first and the second rolls was shaped and cooled while being wrapped around the third roll without being nipped between the second and the third rolls. Therefore, the thermoplastic resin failed to be brought into dose contact with the third roll evenly and, as a result, the resulting extruded resin sheet was poor in appearance.

The following assumption is made with Comparative Examples 2, 3, 5 to 7 and 9. Since roll configuration 2 was used, in other words, a molten thermoplastic resin was shaped and cooled while being nipped between three metal rolls, the rolls were not able to come into areal contact with the molten thermoplastic resin and the molten thermoplastic resin was not in close contact with the third roll evenly, and therefore the resulting extruded resin sheets became poor in appearance.

In Comparative Examples 4, 8 and 10 in which only the first roll was let be an elastic roll, a thermoplastic resin after being nipped between the second and the third rolls failed to be brought into dose contact with the third roll evenly and, as a result, the resulting extruded resin sheets were poor in appearance.

TABLE 2

| | | | | | | | | | | State | | | | |
|---|---|---|---|---|---|---|---|---|---|---|---|---|---|---|
| | Extruder 1 | | | Extruder 2 | | | | | | of | First | | | |
| | Resin | | | Resin | | | Total | Roll configuration | | contact | roll | Second roll | Third roll | |
| | Layer | | Thick- | layer | | Thick- | thick- | | Between | with | surface | surface | surface | |
| | A | Th | ness | B | Th | ness | ness | | second and | third | temp. | temp. | temp. | |
| | Kind | ° C. | mm | Kind | ° C. | mm | mm | Kind | third rolls | roll | ° C. | ° C. | ° C. | Appearance |
| Example 10 | 1 | 100 | 1 | | | | 1 | 1 | Compression | ◯ | 82 | 86 | 88 | ◯ |
| Comparative | 1 | 100 | 1 | | | | 1 | 1 | Compression | Δ | 72 | 76 | 77 | X¹ |
| Example 11 | | | | | | | | | | | | | | |
| Example 11 | 1 | 100 | 1 | | | | 1 | 1 | Compression | ◯ | 107 | 118 | 114 | ◯ |
| Comparative | 1 | 100 | 1 | | | | 1 | 1 | Compression | ◯ | 122 | 128 | 132 | X² |
| Example 12 | | | | | | | | | | | | | | |
| Example 12 | 2 | 140 | 0.45 | 3 | 100 | 0.05 | 0.5 | 1 | Compression | ◯ | 126 | 130 | 131 | ◯ |
| Comparative | 2 | 140 | 0.45 | 3 | 100 | 0.05 | 0.5 | 1 | Compression | Δ | 114 | 117 | 120 | X¹ |
| Example 13 | | | | | | | | | | | | | | |
| Example 13 | 2 | 140 | 0.45 | 3 | 100 | 0.05 | 0.5 | 1 | Compression | ◯ | 141 | 137 | 138 | ◯ |
| Comparative | 2 | 140 | 0.45 | 3 | 100 | 0.05 | 0.5 | 1 | Compression | ◯ | 163 | 158 | 160 | X² |
| Example 14 | | | | | | | | | | | | | | |

¹Warpage and Contact Failure
²Strong Detachment Line

As shown in Table 2, in Examples 10 to 13, it was obtained a smooth extruded resin sheet in which strain, unevenness, and so on were inhibited to occur.

On the other hand, in Comparative Examples 11 to 14, the resulting extruded resin sheet was poor in appearance. In Comparative Examples 11 and 13, too law forming temperature caused warpage in the extruded film. In Comparative Examples 12 and 14, too high forming temperature caused detachment marks on the film surface.

What is claimed is:

1. A method for producing an extruded resin sheet comprising:
heat-melting a thermoplastic resin and then extruding it into a sheet-form through a die;
pressure-forming the extruded molten thermoplastic resin with a first roll and a second roll; and
further pressure-forming the formed resin with the second roll and a third roll while wrapping the formed resin around the second roll,
wherein the first roll is a roll having an outer circumferential surface of metal, the second roll is a highly rigid metal roll, and the third roll is an elastic roll having a metal thin film at its outer circumferential surface.

2. The method for producing an extruded resin sheet according to claim 1, wherein the molten thermoplastic resin nipped between the elastic roll and the metal roll is pressed areally and uniformly because the elastic roll elastically deforms concavely along the outer circumferential surface of the metal roll with the molten thermoplastic resin intervening therebetween, so that the metal roll and the elastic roll are placed in areal contact with the molten thermoplastic resin under pressure.

3. The method for producing an extruded resin sheet according to claim 1, wherein the surface temperature (Tr) of the second and the third rolls is adjusted to within a range of (Th−20° C.)≦Tr≦(Th+20° C.) wherein Th is heat distortion temperature of the thermoplastic resin constituting the extruded resin film.

4. The method for producing an extruded resin sheet according to claim 1, wherein a contact length of the second roll and the third roll is from 1 to 15 mm.

5. The method for producing an extruded resin sheet according to claim 1, wherein a pressing linear pressure between the second roll and the third roll is from 1 to 70 kgf/cm.

6. The method for producing an extruded resin sheet according to claim 1, wherein the third roll comprises an almost solidly-cylindrical core roll, a hollowly-cylindrical metal thin film disposed so that it covers the outer circumferential surface of the core roll, and a fluid enclosed between the core roll and the metal thin film.

7. The method for producing an extruded resin sheet according to claim 1, wherein the first roll is an elastic roll having a metal thin film at its outer circumferential surface.

8. The method for producing an extruded resin sheet according to claim 1, wherein the surface temperature (Tr) of the first to third rolls is adjusted to within a range of (Th−20° C.)≦Tr≦(Th+20° C.) wherein Th is heat distortion temperature of the thermoplastic resin constituting the extruded resin film.

9. The method for producing an extruded resin sheet according to claim 1, wherein the extruded resin sheet has a thickness of 2 mm or less.
